(19) United States
(12) Patent Application Publication
(10) Pub. No.: US 2002/0134468 A1
(43) Pub. Date: Sep. 26, 2002

(54) Aluminum containing iron-based alloys with enhanced ferromagnetic properties

(76) Inventors: Budda V. Reddy, Richmond, VA (US); Seetharama C. Deevi, Midlothian, VA (US); Shiv N. Khanna, Midlothian, VA (US)

Correspondence Address: Peter K. Skiff, Esq., BURNS, DOANE, SWECKER & MATHIS, L.L.P., P.O. Box 1404, Alexandria, VA, 22313-1404, US

(21) Appl. No.: 09/812,580

(22) Filed: Mar. 21, 2001

(51) Int. Cl. H01F 1/147

(52) U.S. Cl. 148/306

(57) ABSTRACT

Aluminum containing iron based alloys with enhanced ferromagnetic properties are provided. The aluminum containing iron based alloys contain additions of palladium and/or rhodium. The alloy can be an ordered, bulk iron-based alloy of the Fe₃Al or FeAl type. In the case of FeAl based alloys, the alloy can contain an amount of palladium and/or rhodium effective to render the alloy ferromagnetic.

### FIELD OF THE INVENTION

The invention relates generally to aluminum containing iron based alloys with enhanced ferromagnetic properties. In particular, the invention relates to aluminum containing iron based alloys further containing palladium and/or rhodium additions.

### BACKGROUND OF THE INVENTION

Iron-aluminide alloys are gaining increasing interest for use as a structural material in place of heavier and more expensive stainless steels. Aluminum containing iron-based alloys can possess levels of resistance to oxidation and sulfidation comparable with and often better than many stainless steels. Of the aluminum containing iron-based alloys presently known, Fe—Al alloys with iron and aluminum concentrations at or near Fe₃Al compositions that have an ordered phase and a lattice structure known as DO₃ at temperatures below about 550° C. have been found to be particularly suitable for use as structural materials in applications requiring relatively high ultimate tensile and yield strength.

Bulk iron and various iron rich alloys possess magnetic properties which are desirable for numerous applications. With increasing aluminum additions, however, the ferromagnetic properties of bulk, ordered aluminum containing iron-based alloys gradually decrease until, at about 35 atomic percent aluminum, binary iron-aluminum alloys become non-magnetic. Thus, while Fe₃Al retains some ferromagnetic properties, FeAl intermetallic alloy compositions, which contain approximately 50 at. % Al, are generally non-magnetic.

Iron based aluminum containing alloys containing up to 50 at. % Al are known, however, which possess ferromagnetic properties. See Caskey et al., J. Phys. Chem. Sol. 34, 1179 (1973). These alloys are disordered alloys obtained by rapid quenching or cold working. For these alloys, it is believed that clusters of Fe atoms in the disordered structure lead to this observed ferromagnetic behavior.

Pd and Rh are known to be non-magnetic materials in bulk. The introduction of ferromagnetic impurities like Fe in bulk Pd, however, has been found to induce relatively large magnetic moments. See, for example, Veerbek et al., Phys. Rev. B22, 5426 (1980). It is also known that small clusters or nano-particles of materials such as Pd or Rh can also exhibit magnetic properties. See, for example, Reddy et al., Phys. Rev. Lett. 70, 3323 (1993).

It would be desirable to recover or enhance the ferromagnetic properties of bulk, ordered aluminum containing iron based alloys while retaining the useful effects of aluminum additions.

### SUMMARY OF THE INVENTION

The invention provides an iron-based aluminum containing alloy including palladium and/or rhodium in an amount effective to enhance magnetic properties of the alloy. The alloy can be an ordered, bulk iron-based aluminum containing alloy having a higher magnetic moment than a Pd and Rh-free ordered, bulk binary iron-aluminum alloy containing the same amount of aluminum. In a preferred embodiment of the invention, the alloy contains an amount of aluminum effective to render an ordered, bulk binary iron-aluminum alloy containing the same amount of aluminum non-magnetic and an amount of palladium and/or rhodium effective to render the alloy ferromagnetic.

A method of enhancing the ferro-magnetic properties of iron-based aluminum containing alloys is also provided. The method includes adding rhodium and/or palladium to the alloy.

### BRIEF DESCRIPTION OF THE DRAWINGS

The invention will be described in greater detail with reference to accompanying drawings in which like elements bear like reference numerals, and wherein:

FIG. 1 shows the lattice structure of an FeAl intermetallic compound having a CsCl structure; and

FIG. 2 shows the lattice structure of FeAl with the central Al atom substituted by a palladium or rhodium atom;

FIG. 3 shows the lattice structure of an Fe₃Al intermetallic compound having a DO₃ structure;

FIG. 4 shows the lattice structure of Fe₃Al with an Fe_{II} atom substituted by a palladium or rhodium atom;

FIGS. 5A and 5B show the total density of states at the Fe site for the Al₂₇Fe₈ cluster of FIG. 1 and the PdAl₂₆Fe₈ cluster of FIG. 2, respectively; and

FIGS. 6A and 6B show the local density of states at the Fe site for the Al₂₇Fe₈ cluster of FIG. 1 and the PdAl₂₆Fe₈ cluster of FIG. 2, respectively.

### DETAILED DESCRIPTION OF THE PREFERRED EMBODIMENTS

The magnetic moment, as measured in units of Bohr Magnetons (μ_{B}), is a measure of the strength of a magnetic material. Iron (Fe) is the strongest ferromagnetic material of the 3d-transition metal series with each of its atoms carrying a moment of about 2.2 μB. The magnetism of iron-based aluminum containing alloys, however, decreases with increasing amounts of aluminum (Al). With low amounts of aluminum (less than about 20 at. %), iron-aluminum alloys are disordered and ferromagnetic properties, as measured by the magnetic saturation moment, decrease with increasing aluminum content at a rate that would be expected from simple dilution. Above this level, however, iron-aluminum alloys become ordered and the magnetic saturation moment falls sharply with increasing aluminum content. Iron-aluminum binary alloys become non-magnetic at aluminum concentrations of approximately 35 atomic percent.

Iron-based alloys containing palladium (Pd) or rhodium (Rh) are known. See, for example, U.S. Pat. Nos. 3,976,479; 4,018,569; 4,098,605; and 4,384,891. The effects of palladium and/or rhodium additions on the ferromagnetic properties of aluminum containing iron based alloys, however, have not been recognized.

The present inventors have surprisingly discovered that impurities of bulk non-magnetic materials such as Pd or Rh can induce a ferromagnetic character in FeAl or enhance the ferromagnetic properties of Fe₃Al. These result have been verified using first-principles density functional calculations. These calculations were quantum mechanical ab initio calculations which are not dependent on any external input.

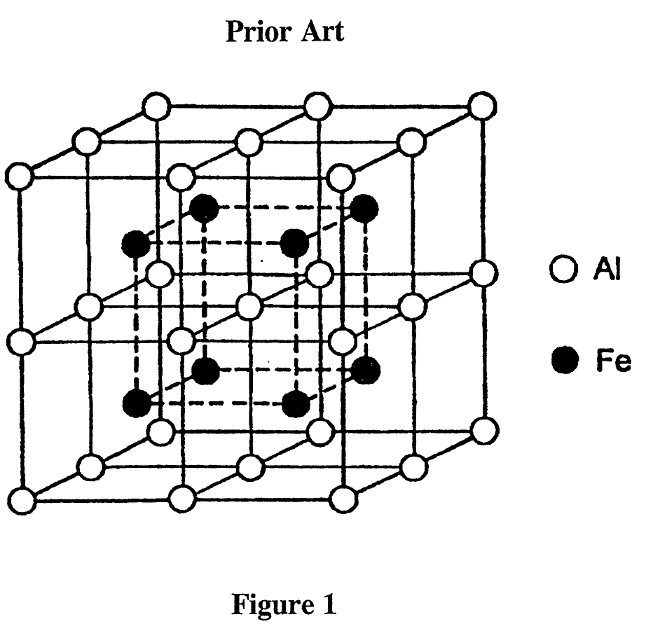

Theoretical calculations were performed on a 35-atom model cluster mimicking the bulk FeAl (50 at. % Al) structure. Bulk FeAl has a CsCl lattice structure which is shown in FIG. 1. According to the calculations, this structure has a nonmagnetic character. This result is in agreement with experimental results for bulk FeAl.

Model calculations were also conducted to determine if a Pd impurity would replace the Fe or the Al site in bulk FeAl. To this end, the total energy of a model cluster of FeAl was calculated by replacing an Al or an Fe site with Pd. It was found that the cluster with a Pd site replacing an Al atom was 0.8 eV more stable than the cluster where the Pd atom replaced a Fe site. This is consistent with a model based on the binding energy of dimers. The binding energy of a Pd—Fe dimer is 3.04 eV compared to 2.7 eV for an Al—Pd dimer. It is therefore more energetically favorable to replace an Al atom with a Pd atom than to replace an Fe atom with a Pd atom.

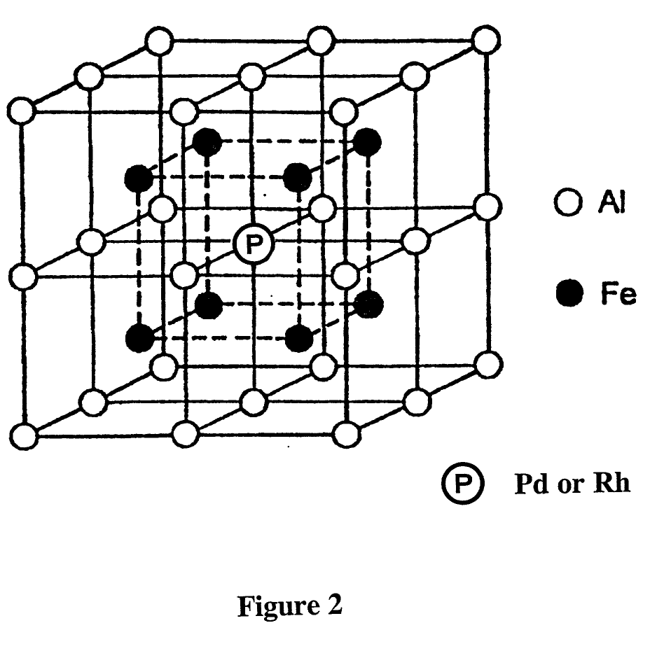

Theoretical calculations were then performed on the FeAl lattice wherein an aluminum atom was substituted by a Pd atom. FIG. 2 shows the central Al atom of FIG. 1 replaced by a Pd atom. With this structure, the calculations revealed that the 8 Fe atoms surrounding the Pd atom experienced enhanced spin polarization thereby attaining a magnetic moment of 0.7 μ_{B}/atom. The ground state was found to be ferromagnetic with the central Pd having a magnetic moment of about −0.02 μ_{B} while the surrounding Fe sites had local magnetic moments of about 0.7 μ_{B} each. A similar calculation substituting a Rh atom for the central Al atom lead to a local magnetic moment of about 0.12 μ_{B} on the central Rh atom while the Fe sites had magnetic moments of about 1.58 μ_{B} each.

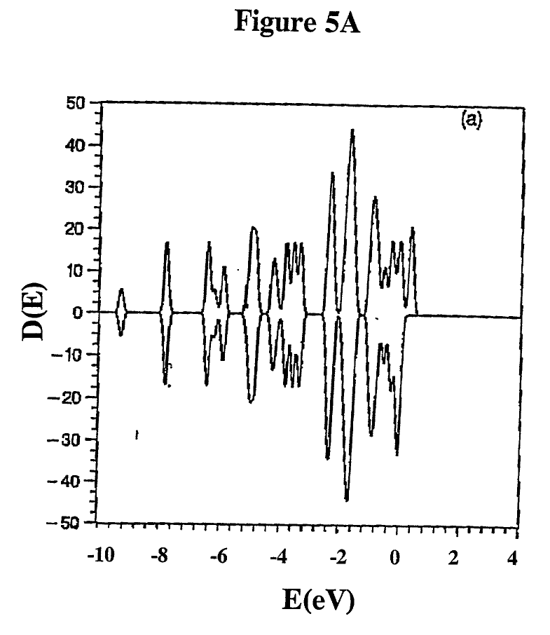

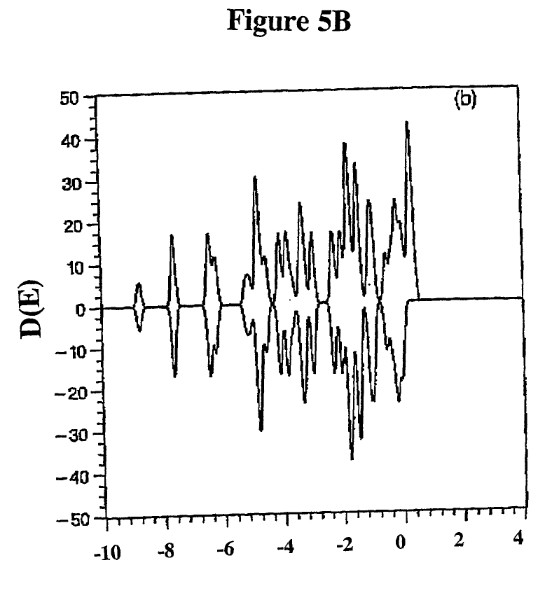

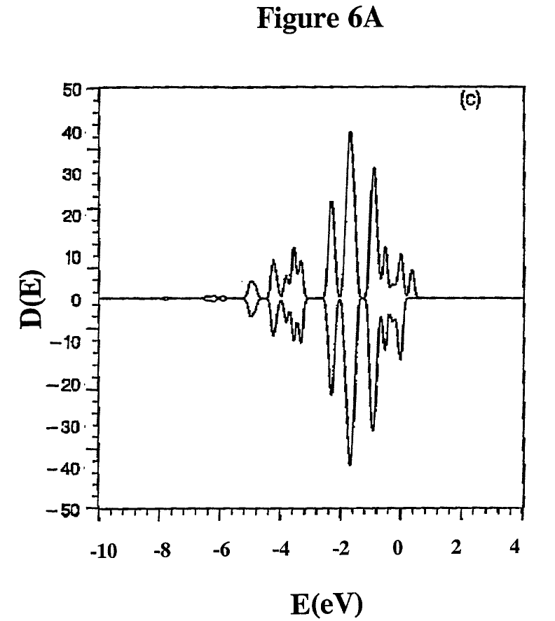

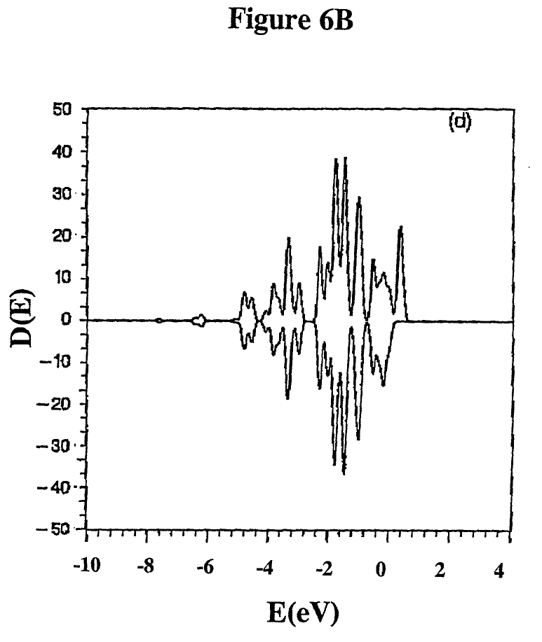

FIGS. 5A and 5B show the total density of states at the Fe site for the Al₂₇Fe₈ cluster (FIG. 1) and the PdAl₂₆Fe₈ cluster (FIG. 2), respectively. FIGS. 6A and 6B show the corresponding local density of states at the Fe site for the Al₂₇Fe₈ cluster and the PdAl₂₆Fe₈ cluster, respectively. As can be seen in FIGS. 5B and 6B, the introduction of Pd induces electronic states at the iron sites which are close to the Fermi energy. This leads to a polarization of the Pd and Fe sites.

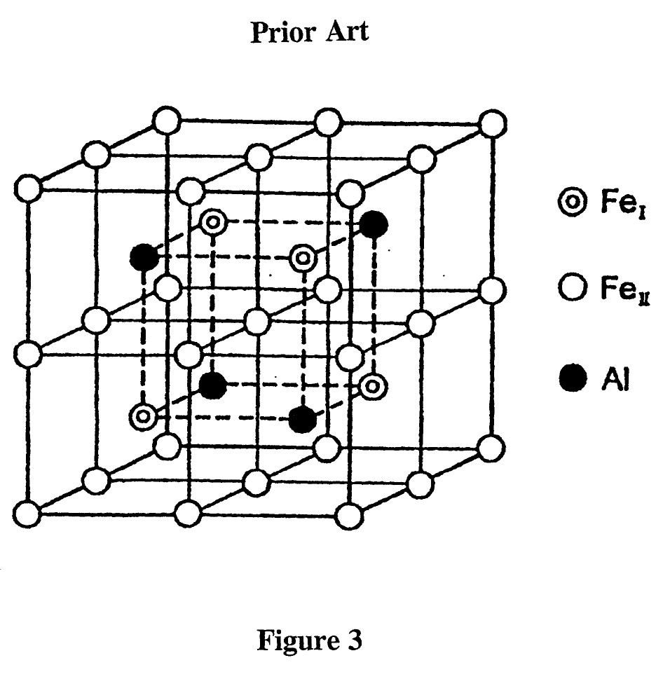

Although the above discussion was directed to FeAl model clusters, the present invention is also applicable to Fe₃Al based intermetallic alloys which are ferromagnetic. With Fe₃Al alloys, the magnetic moment can be enhanced by implanting palladium or rhodium impurities. To this end, calculations were also conducted on an Fe₃Al (25 at. % Al) structure. This stoichiometric intermetallic composition is ferromagnetic and stabilizes in the DO₃ structure which is shown in FIG. 3. This lattice structure comprises two types of Fe sites. The Fe_{I} sites have four Fe and four Al neighbors. According to calculations, these Fe atoms exhibit magnetic moments of about 1.46 μ_{B}. The Fe_{II} sites have eight Fe neighbors and, according to the calculations, exhibit magnetic moments of 2.16 μ_{B}.

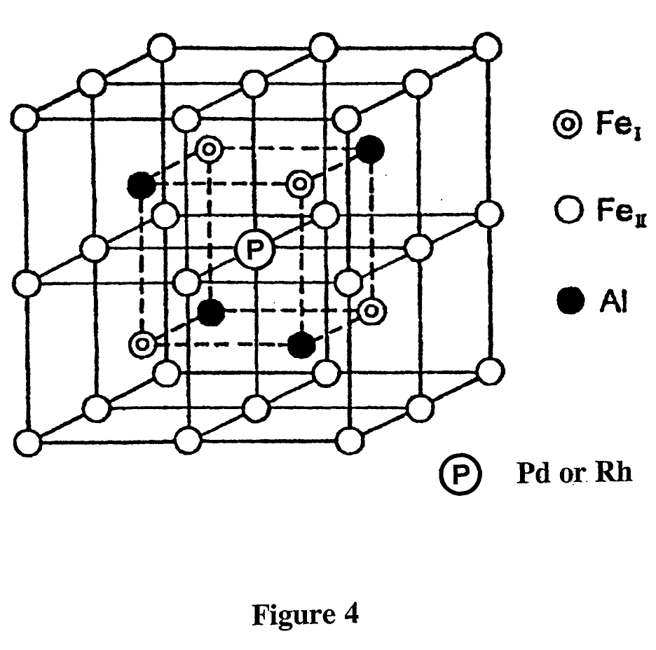

It was found that Pd and Rh impurities will preferentially occupy the Fe_{II} sites in the Fe₃Al lattice. FIG. 4 illustrates the Fe₃Al lattice wherein an Fe_{II} site is occupied by a palladium or rhodium atom. Calculations conducted on this structure indicated that when a Pd impurity occupies an Fe_{II} site, the magnetic moment on Fe atoms surrounding the Pd impurity is enhanced by about 30%. Similarly, calculations indicated that when a Rh impurity occupies an Fe_{II} site, the magnetic moment on surrounding Fe atoms is enhanced by about 12%. In addition, the Rh atom, when substituted in an Fe_{II} site of the Fe₃Al lattice, maintains a magnetic moment of about 0.7 μ_{B} which is equivalent to the value exhibited by a nickel atom in bulk nickel. This result is particularly surprising since bulk Rh is a nonmagnetic metal.

In the present invention, Pd and/or Rh can be added to the alloy in an amount effective to increase the magnetic moment of the alloy. For example, the Pd and/or Rh additions can comprise up to about 20 wt. % of the alloy. In a preferred embodiment, the Pd and/or Rh additions comprise from about 3 to about 15 wt. % of the alloy. More preferably, the Pd and/or Rh additions comprise from about 6% to about 12% by weight of the alloy.

The theoretical calculations set forth above were carried out using a linear combination of atomic orbital/molecular orbital approach. The exchange correlation contributions were included via a gradient corrected density functional. See, for example, Perdew et al., Phys. Rev. B45, 13224 (1992). The actual studies used the DMOL code wherein the atomic orbitals were expressed in numerical form over a mesh of points. See, for example, B. Delley, J. Chem. Phys. 92, 508 (1990). The hamiltonian integrals needed to solve the Kohn-Sham equation were obtained by numerically integrating over a mesh of points. See, for example, Kohn et al., Phys. Rev. 140, A1133 (1965). The calculations were done at the all-electron level. Double numeric basis sets with polarization functions for Fe and Al were used. In all cases, broken symmetry solutions were attempted to look for possible antiferromagnetic states. Finally, to examine the effect of basis sets and the numerical procedure, supplementary calculations were also carried out on a few systems wherein the atomic orbitals were expressed as a linear combination of Gaussian type basis sets and most of the integrals were carried out analytically. In these calculations, the basis sets for Al had 13s, 9p and 1d orbitals and the basis sets for Fe had 15s, 9p and 5d Gaussians. The basis sets were not contracted thus allowing maximal variational freedom. Details of this approach are disclosed by Reuse et al. in Phys. Rev. B41, 11743 (1990).

The present invention can be used to fabricate high strength iron-aluminides with tailored magnetic properties. The alloys can be used in various applications including, but not limited to, electric generators, motors, transformers and any machinery requiring energy from magnetic forces. The alloys could also be used for high temperature aggressive environments.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. An iron-based aluminum containing alloy including palladium and/or rhodium in an amount effective to enhance magnetic properties of the alloy.

2. The alloy of claim 1, wherein the alloy comprises an ordered, bulk iron-based aluminum containing alloy, wherein the alloy comprises additions of palladium and/or rhodium, and wherein the alloy has a higher magnetic moment than an ordered, bulk binary iron-aluminum alloy containing the same amount of aluminum.

3. The alloy of claim 1, wherein the alloy contains at least 10 weight percent aluminum and from 6 to 12 weight percent of the palladium and/or rhodium.

4. The alloy of claim 2, wherein the alloy is an ordered alloy having a DO₃ or a CsCl lattice structure.

5. The alloy of claim 4, wherein the alloy comprises an intermetallic compound selected from the group consisting of FeAl and Fe₃Al.

6. The alloy of claim 1, wherein the alloy contains an amount of aluminum effective to render an ordered, bulk binary iron-aluminum alloy containing the same amount of aluminum non-magnetic and wherein the alloy further comprises an amount of palladium and/or rhodium effective to render the alloy ferromagnetic.

7. The alloy of claim 6, wherein the alloy comprises from 6 to 12 weight percent of the palladium and/or rhodium additions.

8. The alloy of claim 6, wherein the alloy comprises the intermetallic compound FeAl.

9. The alloy of claim 6, wherein the alloy comprises at least 35 atomic percent aluminum.

10. A method of enhancing the ferro-magnetic properties of iron-based aluminum containing alloys comprising adding rhodium and/or palladium thereto.

11. The method of claim 10, further comprising adding from 6 to 12 weight percent of palladium and/or rhodium to the alloy.

12. The method of claim 10, wherein the alloy has an ordered lattice structure comprising iron and aluminum atoms and wherein the method further comprises substituting palladium and/or rhodium atoms into the lattice structure of the alloy such as to increase the magnetic moment of neighboring atoms.

13. The method of claim 12, wherein the alloy is in bulk form and contains an amount of aluminum effective to render a binary bulk iron-aluminum alloy containing the same amount of aluminum non-magnetic, wherein the amount of palladium and/or rhodium added to the alloy is effective to render the alloy ferromagnetic.

14. The method of claim 12, wherein the palladium and/or rhodium atoms are substituted for aluminum atoms in the lattice structure.
